(19) United States
(12) Patent Application Publication
(10) Pub. No.: US 2026/0220074 A1
(43) Pub. Date: Jul. 30, 2026

(54) SERIAL PERIPHERAL INTERFACE BUS TOPOLOGY WITH MULTIPLEXED CHIP SELECT ADDRESSING

(71) Applicant: GM GLOBAL TECHNOLOGY OPERATIONS LLC, DETROIT, MI (US)

(72) Inventors: Peter Rolf Irgens, Novi, MI (US); Nicholas Logan Harvell, Brownstown, MI (US); S.M. Nayeem Hasan, Novi, MI (US)

(21) Appl. No.: 19/040,343

(22) Filed: Jan. 29, 2025

(51) Int. Cl. G06F 13/42

(52) U.S. Cl. CPC G06F 13/4282; G06F 2213/0002

(57) ABSTRACT

Examples described herein provide a method that includes determining whether a software request at a microcontroller unit (MCU) is pending, the software request being to read data from an serial peripheral interface (SPI) device or write the data to the SPI device. The method further includes, responsive to determining that the software request is pending, driving, by the MCU, a column select signal and a row select signal with an SPI device address associated with the SPI device. The method further includes decoding, by a chip select decoder logic, the column select signal and the row select signal. The method further includes performing, by the MCU, an SPI transaction with the SPI device selected from the plurality of SPI devices, the SPI transaction being one of reading the data from the SPI device or writing the data to the SPI device.

### BACKGROUND

The subject disclosure relates to vehicles, and in particular to serial peripheral interface bus topology with multiplexed chip select addressing.

Serial Peripheral Interface (SPI) is a synchronous communication protocol used to transfer data between a commander device (sometimes referred to as a “master” device) and one or more responder devices (sometimes referred to as “slave” devices). SPI often operates with a simple four-wire configuration: clock (SCLK), master out/slave in (MOSI), master in/slave out (MISO), and slave select (SS) (sometimes referred to as “chip select” (CS)). SPI is known for its high speed and efficiency in transmitting data over short distances.

In vehicles, SPI is widely used for communication between microcontrollers and peripherals, such as sensors, displays, and control modules. SPI is commonly used with electronic control unit (ECUs) in vehicles. ECUs are specialized computing modules that manage various automotive systems, such as engine control, transmission, braking, and infotainment. SPI provides a reliable and efficient means of communication between the ECU's microcontroller and peripheral devices or other components. For instance, an ECU might use SPI to interface with sensors (e.g., temperature sensor, pressure sensor, or position sensor), memory modules, or other subsystems that require fast and synchronized data exchange. The simplicity and speed of SPI make it a useful choice for automotive applications where low-latency communication is desired. For example, SPI enables rapid data exchange with devices like tire pressure monitoring systems, engine control sensors, or infotainment components, ensuring real-time performance in critical automotive functions.

The desire for improved SPI communication remains.

### SUMMARY

In one embodiment, a method is provided. The method includes determining whether a software request at a microcontroller unit (MCU) is pending, the software request being to read data from an serial peripheral interface (SPI) device or write the data to the SPI device, the SPI device being selected from a plurality of SPI devices arranged in an SPI device matrix and being electrically connected to the MCU. The method further includes, responsive to determining that the software request is pending, driving, by the MCU, a column select signal and a row select signal with an SPI device address associated with the SPI device. The method further includes decoding, by a chip select decoder logic, the column select signal and the row select signal, wherein the chip select decoder logic is electrically connected to each of the plurality of SPI devices. The method further includes performing, by the MCU, an SPI transaction with the SPI device selected from the plurality of SPI devices, the SPI transaction being one of reading the data from the SPI device or writing the data to the SPI device.

In addition to one or more of the features described herein, or as an alternative, further embodiments of the method may include that the MCU and the plurality of SPI devices form an SPI bus.

In addition to one or more of the features described herein, or as an alternative, further embodiments of the method may include that, prior to determining whether the software request at the MCU is pending, the SPI bus is in an idle state.

In addition to one or more of the features described herein, or as an alternative, further embodiments of the method may include determining whether the SPI transaction is complete, responsive to determining that the SPI transaction is complete, returning the SPI bus to the idle state.

In addition to one or more of the features described herein, or as an alternative, further embodiments of the method may include that the SPI bus further includes a master out/slave in (MOSI) line, a serial clock (SCLK) line, a master in/slave out (MISO) line, and a chip select (CS) line.

In addition to one or more of the features described herein, or as an alternative, further embodiments of the method may include that the MCU is electrically connected to the plurality of SPI devices via at least the chip select decoder logic.

In addition to one or more of the features described herein, or as an alternative, further embodiments of the method may include that the MCU is further electrically connected to the plurality of SPI devices via at least a multiplexer and a buffer.

In addition to one or more of the features described herein, or as an alternative, further embodiments of the method may include that the buffer includes a SCLK buffer and a MOSI buffer.

In addition to one or more of the features described herein, or as an alternative, further embodiments of the method may include that the multiplexer includes a MISO multiplexer.

In addition to one or more of the features described herein, or as an alternative, further embodiments of the method may include that decoding, by the chip select decoder logic, the column select signal and the row select signal further includes determining which of the plurality of SPI devices is the SPI device based at least in part on the column select signal and the row select signal.

In addition to one or more of the features described herein, or as an alternative, further embodiments of the method may include that a configuration of the chip select decoder logic is based at least in part on a number of SPI devices of the plurality of SPI devices.

In addition to one or more of the features described herein, or as an alternative, further embodiments of the method may include that the chip select decoder logic includes a plurality of chip select decoders and a row address decoder.

In addition to one or more of the features described herein, or as an alternative, further embodiments of the method may include that the chip select decoder logic includes a plurality of chip select decoders and inversion logic.

In addition to one or more of the features described herein, or as an alternative, further embodiments of the method may include that the chip select decoder logic includes a plurality of chip select decoders.

In another embodiment, a vehicle having a communication circuit is provided. The communication circuit includes a microcontroller unit, a multiplexer, a buffer, a chip select decoder logic, and a serial peripheral interface (SPI) device matrix having a plurality of SPI devices, each of the plurality of SPI devices electrically connected to the MCU via the multiplexer, the buffer, and the chip select decoder logic, each of the plurality of SPI devices being selectively addressable by the MCU via the chip select decoder logic.

In addition to one or more of the features described herein, or as an alternative, further embodiments of the vehicle may include that the MCU and the plurality of SPI devices form an SPI bus, wherein the SPI bus further includes a master out/slave in (MOSI) line, a serial clock (SCLK) line, a master in/slave out (MISO) line, and a chip select (CS) line.

In addition to one or more of the features described herein, or as an alternative, further embodiments of the vehicle may include that the buffer includes a SCLK buffer and a MOSI buffer, and wherein the multiplexer includes a MISO multiplexer.

In addition to one or more of the features described herein, or as an alternative, further embodiments of the vehicle may include that a configuration of the chip select decoder logic is based at least in part on a number of SPI devices of the plurality of SPI devices.

In addition to one or more of the features described herein, or as an alternative, further embodiments of the vehicle may include that the chip select decoder logic includes a plurality of chip select decoders.

In another embodiment a communication circuit is provided. The communication circuit includes a microcontroller unit, a multiplexer, a buffer, a chip select decoder logic, and a serial peripheral interface (SPI) device matrix including a plurality of SPI devices, each of the plurality of SPI devices electrically connected to the MCU via the multiplexer, the buffer, and the chip select decoder logic, each of the plurality of SPI devices being selectively addressable by the MCU via the chip select decoder logic.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a vehicle with a communication circuit according to one or more embodiments;

FIG. 2 illustrates a circuit diagram of the communication circuit of FIG. 1 according to one or more embodiments;

FIGS. 3A-3E together illustrate a circuit diagram of the communication circuit of FIG. 1 according to one or more embodiments; and

FIG. 4 illustrates a flow diagram of a method for serial peripheral interface bus topology with multiplexed chip select addressing according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term “controller” (e.g., an automotive electronic controller) refers to a dedicated controller including a processor and a memory, a general controller including control modules configured to enact a control process using the dedicated controller, a network of multiple distinct controllers in communication with each other and each including processors and memory and being configured to cooperatively implement the control process, and any similar configuration for implementing the control process.

One or more embodiments described herein relates to serial peripheral interface bus topology with multiplexed chip select addressing.

In modern vehicles, the desire for efficient and reliable communication between microcontrollers and peripheral devices is significant. Serial peripheral interface (SPI) is a widely used synchronous communication protocol that facilitates data transfer between a commander device, such as a microcontroller (also referred to as an “MCU”), and multiple responder devices, including sensors, displays, and control modules. SPI is favored for its high-speed data transmission capabilities and simplicity, typically operating with a four-wire configuration: clock (SCLK) (also referred to as “SPI bus clock”), master out/slave in (MOSI) (also referred to as “SPI bus serial data, MCU output/SPI device input”), master in/slave out (MISO) (also referred to as “SPI bus serial data, MCU input/SPI device output”), and slave select (SS) (also referred to as “chip select” (CS)). In automotive applications, SPI plays a role in the operation of electronic control units (ECUs), which manage various systems, such as engine control, transmission, and infotainment. The ability of SPI to provide low-latency communication is useful for real-time performance in essential automotive functions.

Despite the advantages, traditional SPI configurations present several limitations, particularly in high-content ECUs (often used in vehicles) that require communication with a large number of SPI devices. Typically, a microcontroller can address only a limited number of devices on a bus due to the constraints of available resources and the total capacitive loading of the SPI bus signals. This limitation often necessitates the use of multiple SPI buses, which increases the consumption of microcontroller I/O pins and can lead to inefficient utilization of resources. Additionally, the increased capacitive loading associated with a large number of SPI devices can significantly reduce data transfer rates, impacting the overall performance and efficiency of the system, and in turn, the vehicle.

The desire for improved SPI communication is important for efficient operation of the vehicle, and as such, it is desirable to provide for serial peripheral interface bus topology with multiplexed chip select addressing.

One or more embodiments address these and other shortcomings by introducing a circuit topology that enables the efficient scaling of SPI communication in vehicles using multiple SPI devices. This topology utilizes a combination of digital multiplexer logic, decoder logic, and buffer logic to redistribute the capacitive loading across the SPI bus signals. By employing a logical matrix addressing scheme, the one or more embodiments allows a microcontroller to communicate with a substantial number of SPI devices using minimal I/O resources. This approach not only enhances data transfer rates by reducing capacitive loading per signal segment but also optimizes the hardware design in terms of printed circuit board (PCB) area and bill of materials (BOM) cost. This scalable solution provides an effective and efficient alternative to traditional SPI approaches, such as using dedicated microcontrollers or complex programmable logic devices, thereby improving the overall efficiency and performance of SPI communication in automotive applications.

One or more embodiments provides for a microcontroller unit to address a substantial number of SPI devices (e.g., 16 to 64 SPI devices) with a single standard SPI interface (4x input/output) and minimal address control outputs. The SPI devices are addressed with column (COL_x) and row (ROW_x) control signals in a logical matrix which is expandable up to 2^{(#of COL_x signal)}×2^{(#of ROW_x signal)}. A multiplicity of decoders allows addressing of each individual SPI device without complex PCB signal routing. Multi-channel buffers duplicate and recondition the serial clock (SCLK) and MOSI data signals in columns up to 2^{(#of COL_x signal)}. A multiplexer allows multiple columns of MISO data signals, up to 2^{(#of COL_x signal)}, to route data back to a single input pin of the MCU.

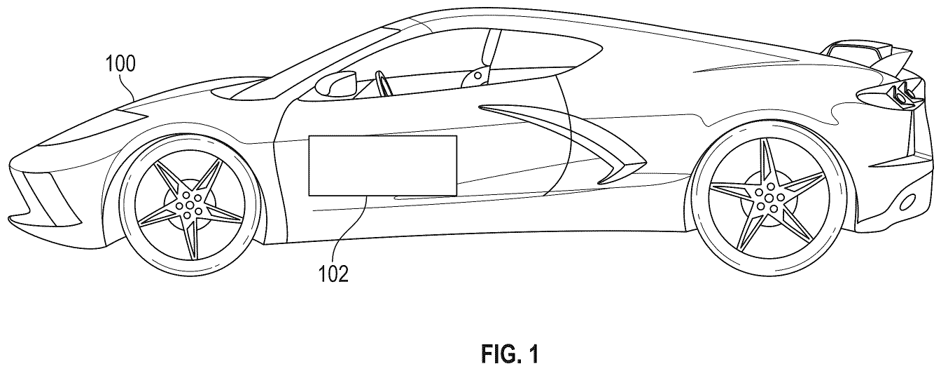

FIG. 1 shows a vehicle 100 with a communication circuit 102 according to one or more embodiments. The vehicle 100 can be a car, a truck, a van, a bus, a motorcycle, a boat, or any other type of automobile. According to an embodiment, the vehicle 100 is a hybrid electric vehicle, such as a plug-in hybrid electric vehicle (PHEV) partially or wholly powered by electrical power. According to another embodiment, the vehicle 100 is an electric vehicle powered by electrical power. A battery (not shown) is used to provide electrical power to components of the vehicle 100, such as an electric motor (not shown), electrical components (not shown), and/or the like, including combinations and/or multiples thereof. According to one or more embodiments, the vehicle 100 includes an internal combustion engine (not shown) that provides electrical and/or mechanical energy for providing propulsion to the vehicle 100. According to one or more embodiments, the vehicle 100 is an autonomous or semi-autonomous vehicle. An autonomous vehicle is a vehicle that has self-driving capabilities. A semi-autonomous vehicle is a vehicle that has certain autonomous features (e.g., self-parking, lane keeping, etc.) but lacks full autonomous control.

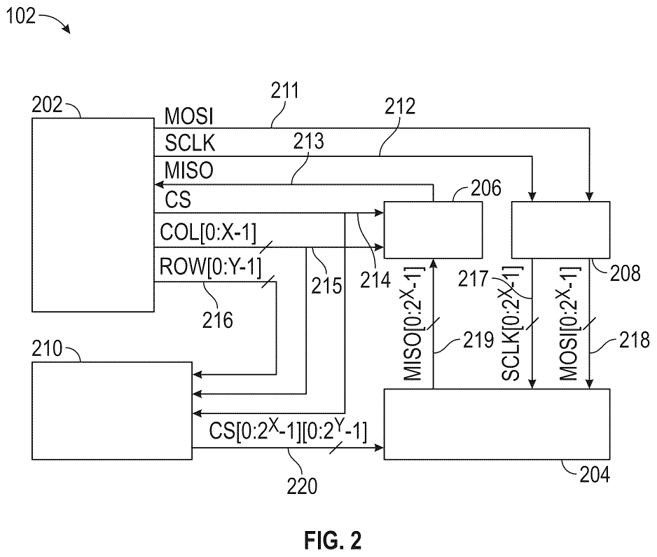

The communication circuit 102 is located within the vehicle 100 and is responsible for employing a logical matrix addressing scheme that enables a microcontroller to communicate with a substantial number of SPI devices using minimal I/O resources. To do this, the MCU addresses any unique SPI device with a unique logic combination of “column” and “row” address signals, and the MCU communicates to the addressed SPI device by use of a standard SPI interface (e.g., SCLK, MOSI, MISO, CS). Further features of the communication circuit 102 are now described with reference to FIG. 2.

Particularly, FIG. 2 illustrates a circuit diagram of the communication circuit 102 of FIG. 1 according to one or more embodiments. According to one or more embodiments, the communication circuit 102 is designed to facilitate efficient communication between a microcontroller unit (MCU) 202 and a SPI device matrix 204 of SPI devices.

The MCU 202 is electrically connected to the SPI device matrix 204 via several components, including a multiplexer (MUX) 206, a buffer 208, and a chip select (CS) decoder logic 210, configured and arranged as shown. The MCU 202 sends and receives signals through various lines: the master out/slave in (MOSI) line 211, the serial clock (SCLK) line 212, the master in/slave out (MISO) line 213, and the chip select (CS) line 214. Together, the MOSI line 211, the SCLK line 212, the MISO line 213, and the CS line 214 form the SPI interface for writing data to and/or reading data from SPI devices of the SPI device matrix 204. According to one or more embodiments, the MOSI line 211, the SCLK line 212, and the MISO line 213 to/from the MUX 206 and buffer 208 are arranged in columns. According to one or more embodiments, there is one CS decoder logic 210 per row of SPI devices, routing unique CS signal to each SPI device which is addressable based on column and row address signals from the MCU 202.

The SPI device matrix 204 is organized in a logical matrix, allowing the MCU 202 to communicate with a substantial number of SPI devices using minimal I/O resources. The MCU 202 addresses any unique SPI device of the SPI device matrix 204 with unique logic combinations of ‘column’ and ‘row’ address signals (e.g., via column select line 215 and row select line 216). The MCU 202 communicates to the addressed SPI device of the SPI device matrix 204 by use of a SPI interface (e.g., the SCLK line 212, the MISO line 213, and the CS line 214).

The MCU 202 also controls a column select line 215 and a row select line 216, which are used to address specific SPI devices within the SPI device matrix 204.

The MUX 206 is responsible for muxing and re-driving the MISO signals from the SPI device matrix 204 to the MCU 202, effectively managing the capacitive loading and routing of these signals back to the MCU 202 through the MISO line 213. According to one or more embodiments, the MUX 206 utilizes digital multiplexer logic with address select inputs and output strobe(s). Multiplexer output logic state is asserted based on the addressed multiplexer input logic state. The MUX 206 re-drives the SPI bus MISO signals from numerous SPI devices, effectively spreading out the total capacitive loading of SPI devices, and routes them back to the MCU from the one multiplexer output.

The buffer 208 is tasked with re-driving the SCLK and MOSI signals from the MCU 202 to the devices of the SPI device matrix 204, distributing them to the selected SPI devices across multiple outputs, as indicated by the SCLK line 217 and the MOSI line 218. This distribution helps to spread out the capacitive loading and enhance data transfer rates. According to one or more embodiments, the buffer 208 utilizes a digital logic buffer with logic input(s) driven from a common signal and numerous logic outputs. The logical state of the outputs match the logical state of the input(s). The buffer 208 re-drives the SPI bus SCLK signal (e.g., SCLK line 212) from the MCU and distributes it (e.g., via SCLK line 217) to the SPI devices of the SPI device matrix 204 across the multiple outputs of the buffers, effectively spreading out the total capacitive loading of SPI devices. According to one or more embodiments, the buffer 208 re-drives the SPI bus MOSI signal (e.g., MOSI line 211) from the MCU 202 and distributes it (e.g., via MOSI line 218) to the SPI devices of the SPI device matrix 204 across the multiple outputs of the buffers, effectively spreading out the total capacitive loading of SPI devices.

The CS decoder logic 210 provides a mechanism for selecting a SPI device of the SPI device matrix 204 as a target device to have data read from or written to. The CS decoder logic 210 is used to decode the CS signals from the MCU 202, distributing them to the appropriate SPI devices within the SPI device matrix 204 via the chip select line 220. The CS decoder logic 210 ensures that the SPI device that is the target device is correctly addressed based on the column and row signals provided by the MCU 202 via column select line 215 and row select line 216. According to one or more embodiments, the CS decoder logic 210 utilizes digital decoder logic with address select inputs and output strobe(s) control inputs. The addressed decoder output is asserted when the strobe(s) is asserted. The CS decoder logic 210 re-drives the SPI bus CS signal (e.g., CS line 214) from the MCU 202 and distributes it to an addressed SPI device.

Decoding of row address signals to CS decoder strobe(s) is achieved by a decoder, discrete logic gates, or direct signal routing from the MCU 202. This combination enables hardware scaling with the number of SPI devices. The hardware design of the communication circuit 102 can be optimized with respect to PCB area, BOM cost, and desired data transfer rates with low capacitive loading per signal segment, providing a scalable and efficient solution for SPI communication in automotive applications.

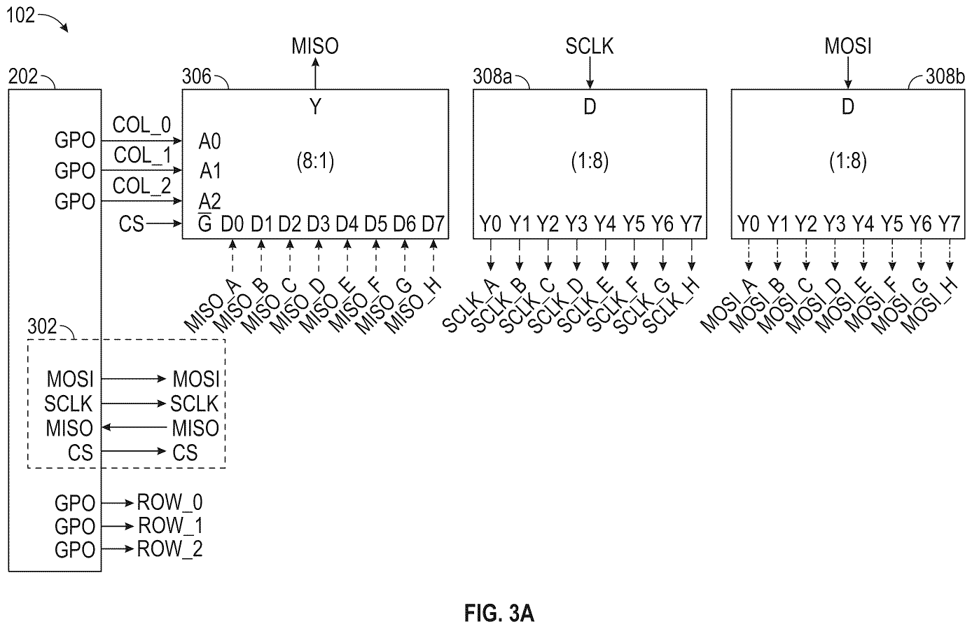

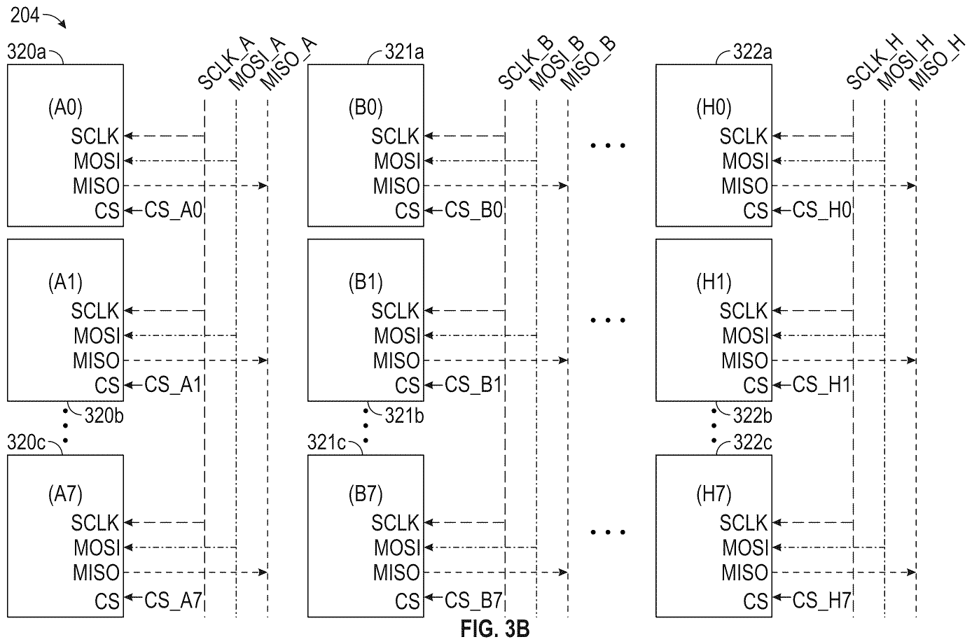

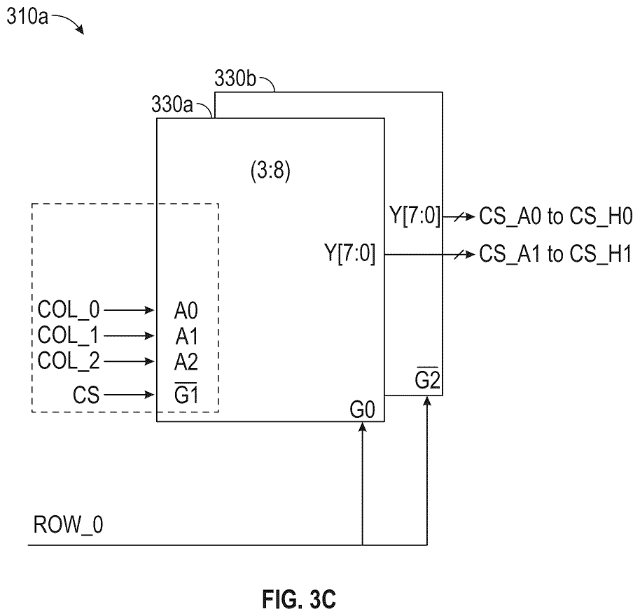

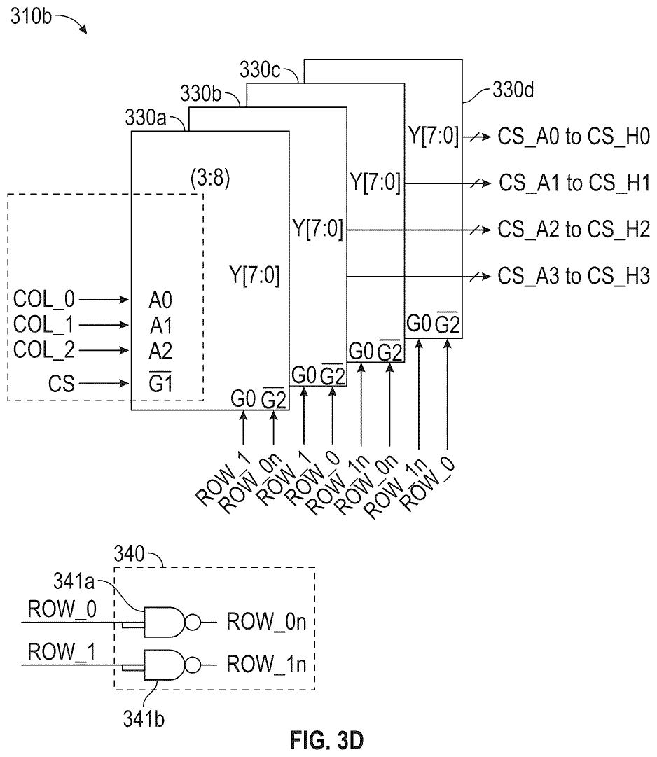

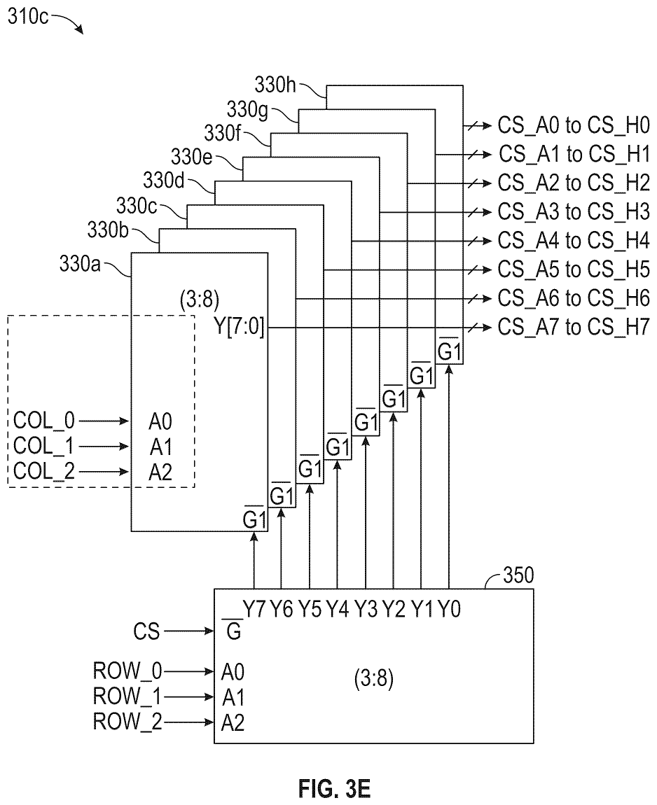

Features and functions of the components of the communication circuit 102 are further described with respect to FIGS. 3A-3E.

In particular, FIGS. 3A-3E together illustrate a circuit diagram of the communication circuit of FIG. 1 according to one or more embodiments. FIGS. 3A-3E are now described together.

FIG. 3A provides a detailed view of a portion of the communication circuit 102, highlighting the interaction between the MCU 202 and various components that facilitate SPI communication. These components include MISO multiplexer 306, SCLK buffer 308a, and MOSI buffer 308b.

The MCU 202 is depicted with several general-purpose input/output (GPIO) lines, which are used to control the column (COL_0, COL_1, COL_2) and row (ROW_0, ROW_1, ROW_2) address signals. These signals are used for selecting specific SPI devices within the SPI device matrix 204. The SPI interface 302 (also referred to as an “SPI bus”) is shown, which is made up of the master out/slave in (MOSI), serial clock (SCLK), master in/slave out (MISO), and chip select (CS) lines. SPI interface 302 is used to facilitate data exchange (e.g., reading and writing data) between the MCU 202 and the SPI devices of the SPI device matrix 204.

The MISO multiplexer 306, which is an example of the MUX 206, is a multiplexer that manages the MISO signals from multiple SPI devices, effectively reducing capacitive loading and routing the signals back to the MCU 202. According to one or more embodiments, the MISO multiplexer 306 is an 8:1 multiplexer but may be configured as other types of multiplexers in other embodiments. The MISO multiplexer 306 is controlled by address inputs A0, A1, and A2, which determine the specific MISO signal to be routed.

The SCLK buffer 308a and the MOSI buffer 308b are depicted, which are examples of the buffer 208 of FIG. 2. Each of the SCLK buffer 308a and the MOSI buffer 308b is configured as a 1:8 buffer according to one or more embodiments, but may be configured as other types of buffers in other embodiments. The SCLK buffer 308a re-drives the SCLK signal from the MCU 202, distributing it to multiple outputs (Y0 to Y7), thereby spreading out the capacitive loading and enhancing data transfer rates to SPI devices of the SPI device matrix 204. Similarly, the MOSI buffer 308b re-drives the MOSI signal, distributing it across multiple outputs (Y0 to Y7) to ensure efficient communication with the SPI devices of the SPI device matrix 204. This configuration allows the communication circuit 102 to handle a substantial number of SPI devices while optimizing the use of I/O resources and maintaining high data transfer rates.

Ax (e.g., A0, A1, A2) represents address select, Dx (e.g., D0, D1, D2, . . . . D7) represents data input, Yx (e.g., Y1, Y2, Y3, . . . . Y7) represents data output, Gx (e.g., G0) represents output strobe active high, G̅x̅ (e.g., G̅2̅) represents output strobe active low, GPO represents general purpose output, COL_x represents SPI device column address, ROW_x represents SPI device row address, and CS_xy represents SPI device chip select at column “x” and row “y.”

FIG. 3B illustrates the SPI device matrix 204, showcasing the organization and interconnection of multiple SPI devices within the matrix. The SPI device matrix 204 is structured in a logical grid, with each SPI device represented by a block, such as SPI device A0 320a, SPI device A1 320b, and SPI device A7 320c in the first column, SPI device B0 321a, SPI device B1 321b, and SPI device B7 321c in the second column, and SPI device H0 322a, SPI device H1 322b, and SPI device H7 322c in the last column. For brevity, certain SPI devices are omitted, but it should be appreciated that, in this embodiment, the SPI device matrix 204 supports 64 SPI devices (8×8). In other embodiments, other numbers of SPI devices can be supported. Each SPI device is connected to the common SPI bus lines, including the SCLK, MOSI, MISO, and CS lines as shown. These lines facilitate communication between the MCU 202 and the SPI devices 320a . . . 322c.

The CS lines (e.g., CS line 220) are uniquely assigned to each SPI device, allowing the MCU 202 to select and communicate with a specific SPI device within the SPI device matrix 204. The SCLK, MOSI, and MISO lines are shared among the devices, enabling synchronized data transfer. The matrix configuration allows for efficient addressing and communication with a large number of SPI devices using minimal I/O resources from the MCU 202. This arrangement optimizes the use of PCB area and reduces the overall capacitive loading on the SPI bus, thereby enhancing data transfer rates and system performance. The logical arrangement of the SPI devices (e.g., SPI devices 320a . . . 322c) in the SPI device matrix 204 provides a scalable solution for managing multiple devices in automotive and other high-content ECU applications.

FIGS. 3C, 3D, and 3E present alternative embodiments of chip select decoder logic arrangements of the CS decoder logic 210 of FIG. 2. Each embodiment is capable of supporting different numbers of SPI devices within the SPI device matrix 204. These figures illustrate various configurations of the CS decoder logic 210, showcasing how the decoder can be adapted to accommodate varying scales of SPI device integration. For example, the embodiment of FIG. 3C supports up to 16 SPI devices using CS decoding for one to two rows, FIG. 3D supports up to 32 SPI devices using CS decoding for three to four rows, and FIG. 3E supports up to 64 SPI devices using CS decoding for five to eight rows. Each configuration employs a combination of digital logic to manage the distribution of chip select signals, ensuring that MCU 202 can efficiently address and communicate with the SPI devices (e.g., SPI devices 320a . . . 322c). The variations in these figures demonstrate the scalability and flexibility of the circuit design of the communication circuit 102, allowing for optimization based on the specific requirements of the application to which the communication circuit 102 is applied.

In FIG. 3C, the first chip select decoder arrangement 310a is depicted, featuring two CS decoders: CS decoder 330a and CS decoder 330b. This configuration is designed to support a relatively smaller number of SPI devices (e.g., up to 16 SPI devices), with each CS decoder 330a, 330b capable of handling a subset of the SPI devices. The CS decoders receive column address signals via column select line 215 of FIG. 3A (e.g., COL_0, COL_1, COL_2 in FIG. 3C) and a chip select signal (CS) from the MCU 202. These signals are used to generate the appropriate chip select outputs (e.g., Y[7:0]) to select the desired (e.g., target) SPI device. The outputs are then routed to the corresponding SPI device, allowing the MCU 202 to select and communicate with the desired SPI device.

FIG. 3D illustrates the second chip select decoder arrangement 310b, which includes four CS decoders (CS decoder 330a, CS decoder 330b, CS decoder 330c, and CS decoder 330d) and additional inversion logic 340. This arrangement is designed to accommodate a larger number of SPI devices, with each CS decoder managing addressing for a specific group of SPI devices. The inversion logic 340, which includes inverters 341a and 341b, is used to manipulate the row address signals (ROW_0, ROW_1) to ensure accurate decoding and selection of the SPI devices. The CS decoders 330a-330d receive the column address signals and the manipulated row address signals as shown, generating the desired chip select outputs for the targeted SPI device.

In FIG. 3E, the third chip select decoder arrangement 310c is shown, featuring eight CS decoders (CS decoder 330a, CS decoder 330b, CS decoder 330c, CS decoder 330d, CS decoder 330e, CS decoder 330f, CS decoder 330g, and CS decoder 330h), and a row address decoder 350. This arrangement is designed for the larger number of SPI devices than the prior arrangements, with each CS decoder 330a-330h responsible for a specific subset of devices. The row address decoder 350 receives the row address signals (ROW_0, ROW_1, ROW_2) and the chip select signal (CS) from the MCU 202 and generates outputs (Y [7:0]) that are fed into the CS decoders 330a-330h as shown. The CS decoders 330a-330h then use these outputs from the row address decoder 350, along with the column address signals (COL_0, COL_1, COL_2), to produce the appropriate chip select signals to select the target SPI device of the SPI device matrix 204. This arrangement provides a highly scalable solution for managing a large number of SPI devices within the SPI device matrix 204.

It should be appreciated that the chip select decoder arrangement can be selected depending on the number of SPI devices. According to one or more embodiments, combinations of the chip select decoder arrangements can be used and/or the chip select decoder arrangements can be modified depending on the number of SPI devices. For example, where 46 SPI devices are used, the third chip select decoder arrangement 310c can be used with a total of six CS decoders (e.g., CS decoders 330a-330f) with the remaining CS decoders (e.g., CS decoders 330g, 330h) omitted. Other configurations and arrangements are possible in various embodiments.

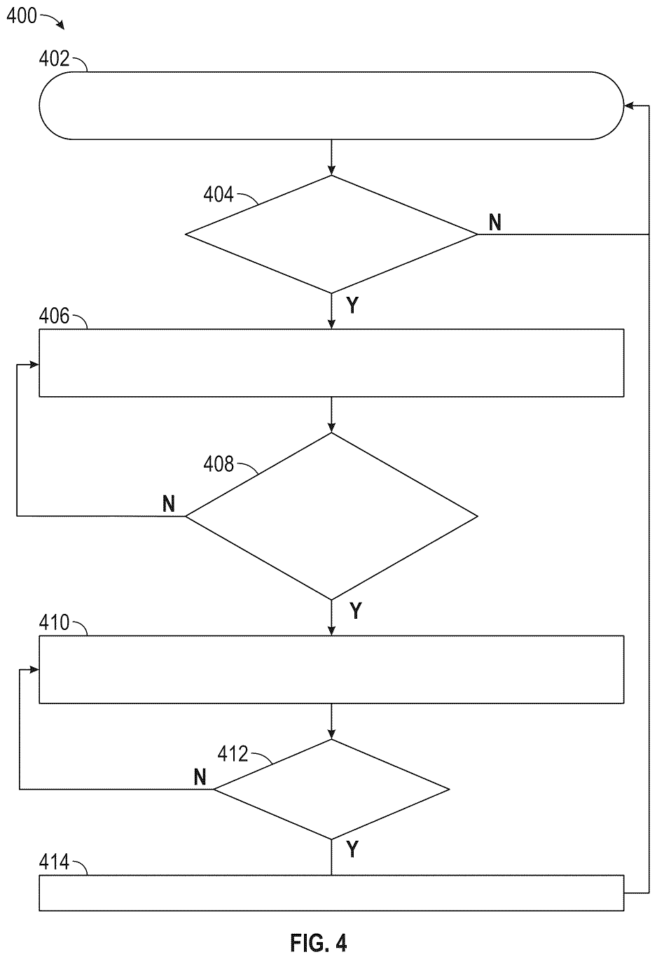

FIG. 4 illustrates a flow diagram of a method 400 for serial peripheral interface bus topology with multiplexed chip select addressing according to one or more embodiments. The method 400 can be implemented using any suitable system or device. For example, the method 400, and its steps, can be implemented using the communication circuit 102 of FIGS. 1, 2, and 3A-3E and/or the like, including combinations and/or multiples thereof. The method 400 is now described with reference to at least portions of the preceding figures but is not so limited.

In Operation 402, the method begins with the SPI bus in an idle state. During this state, the chip select (CS) signal is not asserted, and there is no SPI traffic occurring within the communication circuit 102. This ensures that the bus is inactive and ready for any new communication requests.

In Operation 404, it is determined whether a software request is pending, the request being a request to write or read data to or from an SPI device (e.g., one of SPI device A0 320a . . . . SPI device H7 322c of FIG. 3B). If no request is detected (Operation 404 “No”), the SPI bus remains in the idle state. However, if a request is present (Operation 404 “Yes”), the method 400 proceeds to Operation 406.

In Operation 406, the microcontroller unit (e.g., MCU 202) drives the column (COL_x) select signal (e.g., column select line 215) and row select signal (ROW_x) (e.g., row select line 216) to logic high or low, corresponding to the address of the specific SPI device to be accessed for reading or writing data. This operation causes selection of the correct SPI device for communication with the MCU 202.

In Operation 408, it is determined whether the multiplexer (e.g., MUX 206, MISO multiplexer 306) and chip select decoders (e.g., chip select decoders 330a-33h) have successfully decoded the COL_x and ROW_x address signals. If the decoding is unsuccessful (Operation 408 “No”), the method 400 returns to Operation 406. If the decoding is successful (Operation 408 “Yes)”, the method 400 proceeds to Operation 410.

In Operation 410, the MCU 202 performs the SPI transaction with the selected SPI device designated in Operation 404 (e.g., one of SPI device A0 320a . . . SPI device H7 322c of FIG. 3B). During this transaction, the clock select signal is asserted, and data is exchanged between the MCU 202 and the SPI device (e.g., one of SPI device A0 320a . . . . SPI device H7 322c of FIG. 3B). This operation involves writing and/or reading data as specified by the initial software request (Operation 404).

In Operation 412, it is determined whether the SPI transaction is complete. If the transaction is not yet finished (Operation 412 “No”), the data exchange is continued at Operation 410. Once the transaction is complete (Operation 412 “Yes”), the method 400 proceeds to Operation 414.

In Operation 414, the SPI bus transitions back to the idle state. This involves de-asserting the chip select signal and ensuring that no SPI traffic is present, effectively resetting the SPI bus for future communication requests.

Additional processes also may be included, and it should be understood that the processes depicted in FIG. 4 represent illustrations, and that other processes may be added, or existing processes may be removed, modified, or rearranged without departing from the scope of the present disclosure. It should also be understood that the processes depicted in FIG. 4 may be implemented as programmatic instructions stored on a non-transitory computer-readable storage medium that, when executed by a processor of a computing system, cause the processor to perform the processes described herein.

The following TABLE 1 represents one possible example of SPI device addressing:

TABLE 1
SPI DEVICE ADDRESSING

| BINARY | | | | | | MAP | |
|---|---|---|---|---|---|---|---|
| COL_2 | COL_1 | COL_0 | ROW_2 | ROW_1 | ROW_0 | COL | ROW |
| 0 | 0 | 0 | 0 | 0 | 0 | A | 0 |
| 0 | 0 | 0 | 0 | 0 | 1 | A | 1 |
| 0 | 0 | 0 | 0 | 1 | 0 | A | 2 |
| 0 | 0 | 0 | 0 | 1 | 1 | A | 3 |
| . . . | . . . | . . . | . . . | . . . | . . . | . . . | . . . |
| 0 | 0 | 1 | 0 | 0 | 0 | B | 0 |
| 0 | 0 | 1 | 0 | 0 | 1 | B | 1 |
| 0 | 0 | 1 | 0 | 1 | 0 | B | 2 |
| 0 | 0 | 1 | 0 | 1 | 1 | B | 3 |
| . . . | . . . | . . . | . . . | . . . | . . . | . . . | . . . |
| 0 | 1 | 0 | 0 | 0 | 0 | C | 0 |
| 0 | 1 | 0 | 0 | 0 | 1 | C | 1 |
| 0 | 1 | 0 | 0 | 1 | 0 | C | 2 |
| 0 | 1 | 0 | 0 | 1 | 1 | C | 3 |
| . . . | . . . | . . . | . . . | . . . | . . . | . . . | . . . |
| 0 | 1 | 1 | 0 | 0 | 0 | D | 0 |
| 0 | 1 | 1 | 0 | 0 | 1 | D | 1 |
| 0 | 1 | 1 | 0 | 1 | 0 | D | 2 |
| 0 | 1 | 1 | 0 | 1 | 1 | D | 3 |
| . . . | . . . | . . . | . . . | . . . | . . . | . . . | . . . |
| 1 | 1 | 1 | 0 | 0 | 0 | H | 0 |
| 1 | 1 | 1 | 0 | 0 | 1 | H | 1 |
| 1 | 1 | 1 | 0 | 1 | 0 | H | 2 |
| 1 | 1 | 1 | 0 | 1 | 1 | H | 3 |
| 1 | 1 | 1 | 1 | 0 | 0 | H | 4 |
| 1 | 1 | 1 | 1 | 0 | 1 | H | 5 |
| 1 | 1 | 1 | 1 | 1 | 0 | H | 7 |
| 1 | 1 | 1 | 1 | 1 | 1 | H | 7 |

The following TABLE 2 represents one possible example of SPI device address mapping:

TABLE 2
SPI DEVICE ADDRESS MAPPING

| | | CS Column Index (COL) | | | | | | | |
|---|---|---|---|---|---|---|---|---|---|
| | | A | B | C | D | E | F | G | H |
| CS | 0 | A0 | B0 | C0 | D0 | E0 | F0 | G0 | H0 |
| Row | 1 | A1 | B1 | C1 | D1 | E1 | F1 | G1 | H1 |
| Index | 2 | A2 | B2 | C2 | D2 | E2 | F2 | G2 | H2 |
| (ROW) | 3 | A3 | B3 | C3 | D3 | E3 | F3 | G3 | H3 |
| | 4 | A4 | B4 | C4 | D4 | E4 | F4 | G4 | H4 |
| | 5 | A5 | B5 | C5 | D5 | E5 | F5 | G5 | H5 |
| | 6 | A6 | B6 | C6 | D6 | E6 | F6 | G6 | H6 |
| | 7 | A7 | B7 | C7 | D7 | E7 | F7 | G7 | H7 |

One or more embodiments offer significant technical benefits, particularly in the context of automotive applications. For example, one or more embodiments described herein provide an innovative circuit topology that enables the efficient scaling of SPI communication, enabling a microcontroller to address a substantial number of SPI devices using minimal I/O resources. This is achieved through the use of digital multiplexer logic, decoder logic, and buffer logic, which collectively redistribute the capacitive loading across the SPI bus signals. By employing a logical matrix addressing scheme, one or more embodiments enhances data transfer rates by reducing capacitive loading per signal segment. This not only optimizes the hardware design in terms of PCB area and BOM cost but also provides a scalable and cost-effective solution compared to existing approaches, such as using dedicated microcontrollers or complex programmable logic devices.

In the context of vehicle 100, one or more embodiments improves the operation of the vehicle 100 by facilitating more efficient and reliable communication between the microcontroller and peripheral devices. This is particularly beneficial for high-content ECUs that utilize communication with a large number of SPI devices. The ability to address up to 64 SPI devices with a single SPI interface and minimal I/O utilization from the MCU significantly reduces the consumption of microcontroller I/O pins. This efficient use of resources allows for the integration of more features and functionalities within the vehicle's electronic systems without compromising performance.

Furthermore, the reduction in capacitive loading per signal segment enables faster signal rise and fall times, which in turn allows for higher SPI transfer rates. This improvement in data transfer speed is useful for real-time performance in certain automotive functions, such as engine control, transmission, and infotainment systems. By ensuring rapid and synchronized data exchange, one or more embodiments enhances the overall efficiency and performance of the vehicle's systems, contributing to improved functionality and user experience. Overall, the described embodiments provide a robust and scalable solution for managing SPI communication in automotive applications, offering technical advantages.

It is understood that one or more embodiments described herein is capable of being implemented in conjunction with any other type of computing environment now known or later developed.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method comprising:
determining whether a software request at a microcontroller unit (MCU) is pending, the software request being to read data from a serial peripheral interface (SPI) device or write the data to the SPI device, the SPI device being selected from a plurality of SPI devices arranged in an SPI device matrix and being electrically connected to the MCU;
responsive to determining that the software request is pending, driving, by the MCU, a column select signal and a row select signal with an SPI device address associated with the SPI device;
decoding, by a chip select decoder logic, the column select signal and the row select signal, wherein the chip select decoder logic is electrically connected to each of the plurality of SPI devices; and
performing, by the MCU, an SPI transaction with the SPI device selected from the plurality of SPI devices, the SPI transaction being one of reading the data from the SPI device or writing the data to the SPI device.

2. The method of claim 1, wherein the MCU and the plurality of SPI devices form an SPI bus.

3. The method of claim 2, wherein, prior to determining whether the software request at the MCU is pending, the SPI bus is in an idle state.

4. The method of claim 3, further comprising:
determining whether the SPI transaction is complete; and
responsive to determining that the SPI transaction is complete, returning the SPI bus to the idle state.

5. The method of claim 2, wherein the SPI bus further comprises a master out/slave in (MOSI) line, a serial clock (SCLK) line, a master in/slave out (MISO) line, and a chip select (CS) line.

6. The method of claim 5, wherein the MCU is electrically connected to the plurality of SPI devices via at least the chip select decoder logic.

7. The method of claim 6, wherein the MCU is further electrically connected to the plurality of SPI devices via at least a multiplexer and a buffer.

8. The method of claim 7, wherein the buffer comprises a SCLK buffer and a MOSI buffer.

9. The method of claim 7, wherein the multiplexer comprises a MISO multiplexer.

10. The method of claim 1, wherein decoding, by the chip select decoder logic, the column select signal and the row select signal further comprises determining which of the plurality of SPI devices is the SPI device based at least in part on the column select signal and the row select signal.

11. The method of claim 1, wherein a configuration of the chip select decoder logic is based at least in part on a number of SPI devices of the plurality of SPI devices.

12. The method of claim 1, wherein the chip select decoder logic comprises a plurality of chip select decoders and a row address decoder.

13. The method of claim 1, wherein the chip select decoder logic comprises a plurality of chip select decoders and inversion logic.

14. The method of claim 1, wherein the chip select decoder logic comprises a plurality of chip select decoders.

15. A vehicle comprising:
a communication circuit comprising:
a microcontroller unit (MCU);
a multiplexer;
a buffer;
a chip select decoder logic; and
a serial peripheral interface (SPI) device matrix comprising a plurality of SPI devices, each of the plurality of SPI devices electrically connected to the MCU via the multiplexer, the buffer, and the chip select decoder logic, each of the plurality of SPI devices being selectively addressable by the MCU via the chip select decoder logic.

16. The vehicle of claim 15, wherein the MCU and the plurality of SPI devices form an SPI bus, wherein the SPI bus further comprises a master out/slave in (MOSI) line, a serial clock (SCLK) line, a master in/slave out (MISO) line, and a chip select (CS) line.

17. The vehicle of claim 16, wherein the buffer comprises a SCLK buffer and a MOSI buffer, and wherein the multiplexer comprises a MISO multiplexer.

18. The vehicle of claim 15, wherein a configuration of the chip select decoder logic is based at least in part on a number of SPI devices of the plurality of SPI devices.

19. The vehicle of claim 15, wherein the chip select decoder logic comprises a plurality of chip select decoders.

20. A communication circuit comprising:
a microcontroller unit (MCU);
a multiplexer;
a buffer;
a chip select decoder logic; and
a serial peripheral interface (SPI) device matrix comprising a plurality of SPI devices, each of the plurality of SPI devices electrically connected to the MCU via the multiplexer, the buffer, and the chip select decoder logic, each of the plurality of SPI devices being selectively addressable by the MCU via the chip select decoder logic.
